(19) United States
(12) Patent Application Publication
(10) Pub. No.: US 2026/0050606 A1
(43) Pub. Date: Feb. 19, 2026

(54) AUDIT MODEL FOR DATA ENGINEERING PIPELINES

(71) Applicant: T-Mobile Innovations LLC, Overland Park, KS (US)

(72) Inventor: Ugandhar DASI, Alpharetta, GA (US)

(21) Appl. No.: 18/807,664

(22) Filed: Aug. 16, 2024

(51) Int. Cl. G06F 16/25; G06F 16/23

(52) U.S. Cl. CPC G06F 16/254; G06F 16/2358

(57) ABSTRACT

A method of detecting an anomaly in data includes feeding data through data pipelines to a centralized repository by running an Extract, Transform, Load (ETL) process on the data; implementing an audit schema to track information about job processing of the ETL process; detecting an anomaly based on a comparison of the information tracked by the audit schema with a threshold; and initiating a corrective action in response to detecting the anomaly. Tables of the audit schema are automatically populated with the information by stored procedures as actions are triggered in the data pipelines.

### CROSS-REFERENCE TO RELATED APPLICATIONS

None.

### STATEMENT REGARDING FEDERALLY SPONSORED RESEARCH OR DEVELOPMENT

Not applicable.

### BACKGROUND

In data management, pipelines may be used for transferring data from various sources to centralized repositories such as data lakes and data warehouses. These pipelines may automate the extraction, transformation, and loading (ETL) processes, ensuring data is accurately and consistently moved to storage systems where it can be used for analysis, reporting, and decision-making. Auditing mechanisms may be integrated within these pipelines to monitor, log, and verify the integrity and completeness of the data throughout its journey. This auditing may ensure compliance with data governance policies and provide a reliable record of data movements and transformations, which may be important for maintaining data quality and trustworthiness in large-scale data environments.

### SUMMARY

In some embodiments, a method of tracking information about job processing of an ETL process, by one or more processors, data through data pipelines to a centralized repository by running an Extract, Transform, Load (ETL) process on the data; implementing, by the one or more processors, an audit schema to track information about job processing of the ETL process, wherein tables of the audit schema are automatically populated with the information by stored procedures as actions are triggered in the data pipelines, wherein the tables are a centralized location for storing the information which relates to flow of the data through the data pipelines, and wherein the tables comprise a job error table for the data pipelines containing information about errors and respective sources of the errors.

In some embodiments, a system for tracking information about job processing of an ETL process includes data pipelines configured to feed data to a centralized repository by running an Extract, Transform, Load (ETL) process on the data; and an audit schema configured to track information about job processing of the ETL process, wherein tables of the audit schema are automatically populated with the information by stored procedures as actions are triggered in the data pipelines, and wherein the tables are a centralized location for storing the information which relates to flow of the data through the data pipelines, and wherein the tables comprise a job metadata table, a Change Data Capture (CDC) table, a job execution log table, a job status table, an audit balance table, a flat file control table, and a job error record table.

In some embodiments, a system for detecting an anomaly in data includes data pipelines configured to feed data to a centralized repository by running an Extract, Transform, Load (ETL) process on the data; an audit schema configured to track information about job processing of the ETL process, wherein tables of the audit schema are automatically populated with the information by stored procedures as actions are triggered in the data pipelines; and an anomaly detector configured to determine a volume of files passing through a data pipeline of the data pipelines using one or more of the tables, comparing the volume of files passing through the data pipeline with a threshold that is based on historical information related to flow through the data pipeline, and outputting an alert to a graphical user interface in response to the volume of the files passing through the data pipeline falling below the threshold.

The tables may include a job metadata table, a change data capture (CDC) table, a job execution log table, a job status table, an audit balance table, a flat file control table, and/or a job error record table. The job metadata table may hold job metadata information and may include source data information and target data information. The CDC dates table may store date ranges for active jobs. The CDC history table may store backed up CDC entries of runs of a previous job. The job execution log table may hold execution log information at a job name and a step layer for each process. The job status table may hold status information of a most recent active job run. The audit balance table may be for computing an audit check between source and target counts. The flat file control table may be for controlling injection and storing metadata of flat files. The job error record table may hold error information.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system for performing an audit, according to an embodiment of the present disclosure;

FIG. 2 is a block diagram of a data management system, according to an embodiment;

FIG. 3 is a block diagram of a data process with an audit, according to an embodiment;

FIG. 4 is a flow diagram of a method for detecting an anomaly in data, according to an embodiment;

FIG. 5 is a schematic diagram of an audit model, according to an embodiment; and

FIG. 6 is a block diagram of a computer system, according to an embodiment.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Different data sources with heterogenous formats and varying frequencies are fed to data lakes and data warehouses to satisfy business needs for near real time data for functional and machine learning use cases. Data observability tools capture the information from extract, transform, load (ETL) logs, which become an overhead when continuous data streams are populating audit logs. Enabling detailed logging on big data systems can be an expensive operation and often cannot be scaled to all data stores, especially when dealing with the huge amount of data. Audit and balance controls as standalone jobs to find missing data in pipelines can be resource intensive. For example, error tables may be created for tens of thousands of data tables when in reality only a small percentage of those error tables will ever be used. The same issue applies for change data capture (CDC) tables.

The system and method of the present disclosure teaches an audit model that captures data about an ETL process that is already processing, and then the collected data can be used for multiple purposes. An audit model may be used so that there is a uniform way of collecting data about jobs processing throughout the system of data pipelines. Anomalies can be detected based on the information tracked by the audit schema. Information about the jobs (e.g., the collected data) and the anomalies may be displayed on a dashboard. The system and method of the present disclosure may provide a holistic view of end-to-end processes and integrate all pipeline artifacts into a single model. The need to create an error table and a CDC table for every data table may be avoided by automatically populating tables of the audit schema as actions are triggered in the data pipeline. Error information may be collected in a single, centralized table that includes a field containing information about the source of the error, thus effectively replacing the tens of thousands of error tables according to the conventional art.

The data stored in the audit schema of the present disclosure may be used, for example, to: determine a particular data pipeline job status (e.g., whether the job is started, in-progress, completed or failed); check how many records were processed by a particular step to further investigate data reconciliation; find different steps in each pipeline and their dependencies; determine what files were received and processed; identify errors and capture them; observe holistic pipeline on top of job status and job execution tables; generate data quality metrics from an audit balance table; detect anomalies in the log tables (e.g., to identify trends of data pipelines); and/or control system ingestion using a CDC table to track what was processed. In some embodiments, the audit model is triggered in response to an ETL process running. In some embodiments, the audit model is integrated into the data pipeline and can detect anomalies automatically.

As used herein, the term “audit model” refers to a conceptual framework that outlines the principles for conducting an audit. As used herein, the term “audit schema” refers to a physical deployment of the audit model (e.g., across one or more cloud systems). The audit schema according to the present disclosure can serve as a centralized data repository for pipeline monitoring, error monitoring, audit, and balance controls.

A system for detecting an anomaly in data may include one or more processors configured to feed data through a data pipeline (e.g., one or more pipelines) to a centralized repository (e.g., one or more repositories such as data lakes and/or data warehouses) by running an ETL process on the data. The system implements an audit schema to track information about job processing of the ETL process. Tables of the audit schema may be automatically populated with the information by stored procedures as actions are triggered in the data pipeline. The tables may be a centralized location for storing information which relates to the flow of data through the data pipelines. An anomaly may be detected based on the information stored by the audit schema. For example, the anomaly may be detected based on a comparison of the information tracked by the audit schema with a threshold. The threshold may be based on historical information received related to flow through the data pipelines. For example, the threshold may be a number of files received in a time period which is stored on one of the tables. The entry in the table for a recent job may be compared to a threshold generated based on an aggregation of past jobs. Outliers may be removed from the historical data to generate the threshold. In response to detecting that a number of files received in a time period is less than the threshold, a corrective action may be initiated. For example, an IT professional may be alerted to investigate the potential issue. In some embodiments, the corrective action may be performed by one or more processors and corrects the flow of data through the data pipelines. For example, proper flow of files through the data pipeline may be restored by the corrective action.

File control tables of the audit schema may be used to store information about what files were loaded, when they were loaded, and/or how many records were received. Jobs may be created such that for every data pipeline job, an audit job is created (e.g., audit balance control). The audit balance control may be used to check accuracy and consistency of data and/or to verify that data is processed correctly. In some embodiments, the audit balance control determines whether any data was missed from the transfer based on how many source records were read, how many source records were processed, and/or how many target records there are. Visibility may be gained into when the pipeline ran, how long the process took, how many records were processed, the presence of any errors, and CDC.

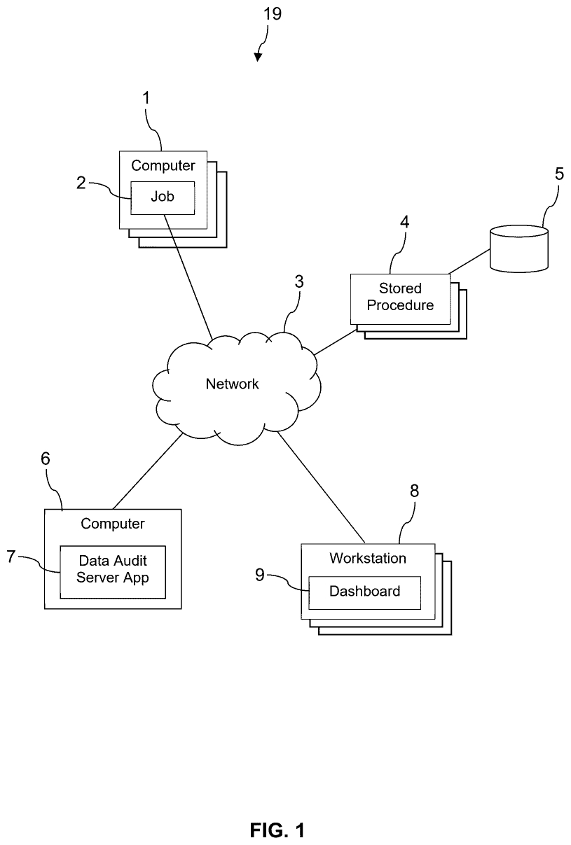

Referring to FIG. 1, a system 19 for performing an audit is shown. The system 19 may include a network 3, computers 1,6, a workstation 8, and a data store 5. Jobs 2 may execute on the computers 1. The jobs 2 may flow data through the network 3 to the data store 5. In the process of writing data into the data store 5, stored procedures 4 may be automatically invoked and conduct activities related to the auditing function. Files may be automatically populated that are specifically associated with the auditing function. A data audit sever application 7 may execute on the computer 6. This data audit server application 7 may perform auditing functions not automatically performed by the stored procedures 4. The stored procedures 4 may include instructions for reading from the tables in the data store 5 to generate and populate the dashboard 9 that executes on a workstation 8. In some embodiments, multiple users of multiple separate workstations 8 (e.g., laptop computer, notebook computer, smart phone, etc.) can be independently running different instances of the dashboard and viewing audit results of interest.

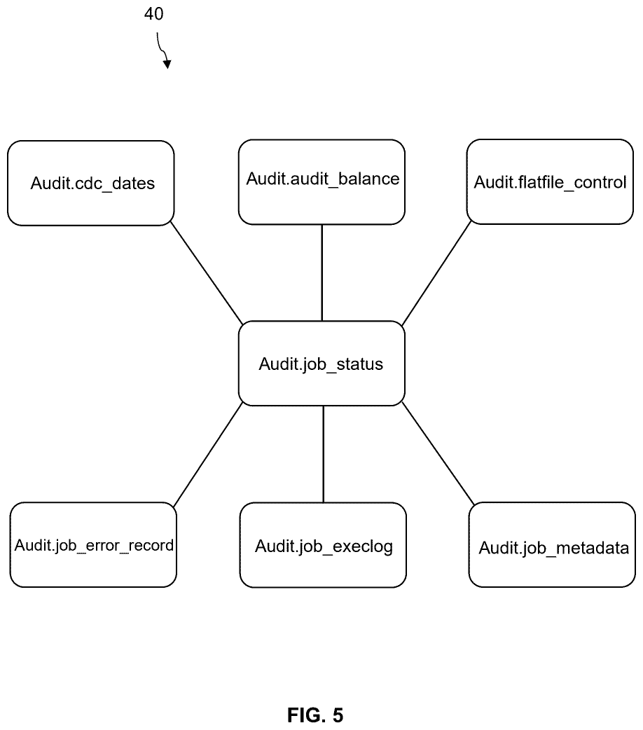

Referring to FIG. 5, the audit model 40 may be made up of several tables that track information about job processing. These audit tables may maintain metadata information about the job's configuration, most recent execution, and the latest and historical CDC entries. The tables used may be identified with a prefix. The tables may include a job metadata table (e.g., “job_metadata”), a CDC table (e.g., “cdc_dates”), a job execution log table (e.g., “job_execlog”), a job status table (e.g., “job_status”), an audit balance table (e.g., “audit_balance”), a flat file control table (e.g., “flat_file_control”), and/or a job error record table (e.g., “job_error_record”). These tables may be automatically populated by stored procedures as and when an appropriate action is triggered in the data pipeline. The term “data pipeline” may refer to an automation of a sequence of processes that extracts, transforms, and loads data from various sources to a data repository. The term “jobs” (within the data pipeline) may refer to execution of ETL processes. All the parameters may be entered by the user at the pipeline level before the pipeline is triggered or configured as parameter files in blob storage. Lookup activities in the pipeline may be utilized to extract the configured values and pass them on as arguments to the corresponding stored procedures. The audit schema may integrate multiple data pipelines and/or multiple platforms by a common architecture.

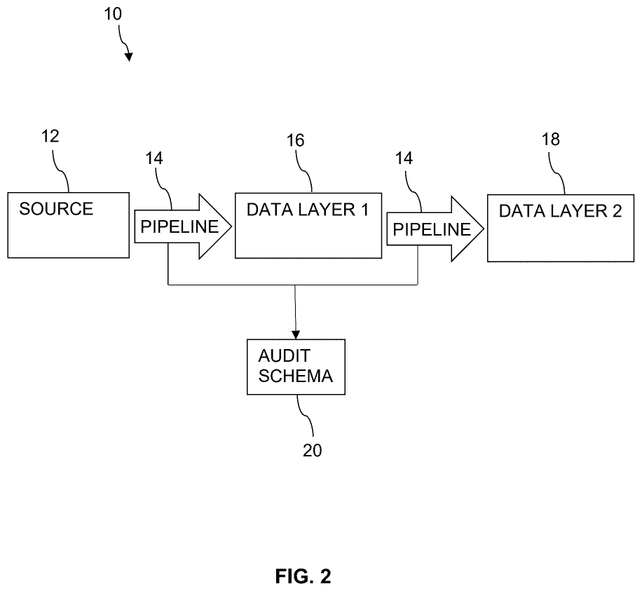

The audit schema of the present disclosure may provide visibility into data pipelines for example, by detecting anomalies. In some embodiments, there may be multiple pipelines and multiple layers. For example, referring to FIG. 2, an exemplary data management system 10 includes a data pipeline 14, a first data layer 16, a second data layer 18, and an audit schema 20. Data may flow from the source 12 through the data pipeline 14 to the first data layer 16. Data may then travel from the first data layer 16 through the data pipeline 14 to the second data layer 18. The data pipeline 14 may facilitate the movement of data from the source 12 to one or more centralized repositories such as data lakes and/or data warehouses by handling tasks such as ETL. The data layers 16,18 may act as an intermediary, thus providing an abstracted interface for accessing and manipulating data and ensuring it is properly managed and secured. The audit schema 20 may log data operations, changes, and/or access activities, thereby maintaining an audit trail according to the audit model of the present disclosure. Results of the audit performed by the audit schema 20 may be displayed on the dashboard 9 for remediation by IT professionals. In some embodiments, an alert is triggered in response to an anomaly being detected by the audit schema 20. For example, the alert may take the form of an email, a message, or an indication on the dashboard 9. The alert may prompt an IT professional to correct the issue causing the anomaly. The audit model may be implemented over the entire cloud-based system, which may have any number of pipelines and layers. In some embodiments, there are 10,000 or more pipelines.

The configuration of the data management system 10 may present the advantage of saving on overhead costs. For example, instead of having an individual error table for each data table (with many going unused), the data management system 10 of the present disclosure may capture errors in a centralized error table of the audit schema 20. The centralized error table may include fields that indicate the source of the data and/or the intended destination of the data. In some embodiments, the jobs are run by ETL frameworks, and the ETL frameworks are used to populate the audit model. In some embodiments, the audit model may trace the lineage of data as it passes through the system. The lineage may show the relationship of the source of the data, the destination of the data, and/or the path the data takes or is intended to take through the system.

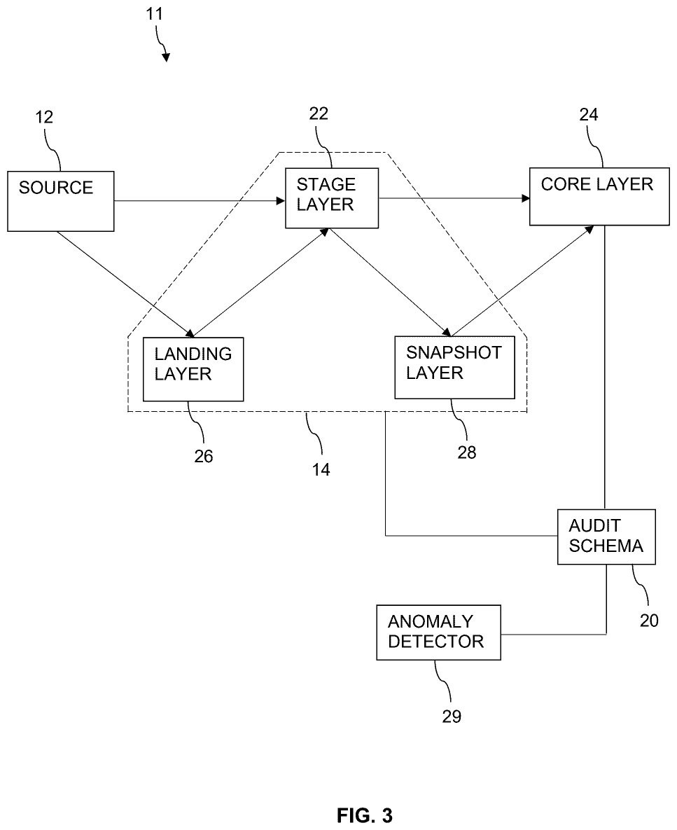

Referring to FIG. 3, a data process 11 with an audit is shown. In the data process 11, data from the source 12 may be transferred through layers (e.g. part of the data pipeline 14) until it reaches the core layer 24. The audit schema 20 may gather information from the data pipeline 14 and/or the core layer 24 to detect anomalies. The source 12 may be the original location of the data, for example, a webpage, transactional databases, application logs, and/or external APIs. Once extracted, the raw data may be transferred to the landing layer 26, which may be a temporary storage zone where the data is first received without any transformation, serving as a buffer that ensures that the data is intact and available for further processing. At the stage layer 22, initial transformations, cleansing, and/or validation may occur to prepare the data for integration and analysis. At the snapshot layer 28, snapshots of the data may be captured at periodic points in time, which may preserve historical states of the data for trend analysis and auditing. At the core layer 24, data that has been cleaned, transformed, and integrated may be stored in a structured manner which may be optimized for querying, analysis, and/or use by an artificial intelligence system. The core layer 24 may support business intelligence, reporting, and/or analytics.

In FIG. 3, load jobs between the layers are denoted by arrows. There may be a load job from the source 12 to the stage layer 22; a load job from the source 12 to the landing layer 26; a load job from the landing layer 26 to the stage layer 22; a load job from the stage layer 22 to the core layer 24; a load job from the stage layer 22 to the snapshot layer 28; and/or a load job from the snapshot layer 28 to the core layer 24. In some embodiments, audit and/or error handling may be performed in a stage load job between the source 12 and the stage layer 22. The audit may include, for example, job status information, CDC date information, flat file control information, and/or job execution log information. The error handling may include, for example, job error information and/or error record information. In a core load job from the stage layer 22 to the core layer 24, audit, error handling, and/or controls may be performed. In a core load job between the snapshot layer 28 and the core layer 24, controls may be performed. At the stage layer 22, a data quality assessment may be performed. At the core layer 24, an audit, balance, and control (ABC) process and/or a metadata process may be performed. The ABC process may include, for example, processing job description, source count, target count, and/or threshold. The metadata process may involve job metadata and/or table metadata. The audit schema 20 may include tables that are populated as the data pipeline 14 transfers data from the source 12 to the core layer 24 through the ETL process. An anomaly may be detected by an anomaly detector 29 based on the information in the tables of the audit schema 20. The anomaly detection may be used to correct issues that may prevent data from being successfully transferred to the core layer 24. The data that successfully reaches the core layer 24 may be accessed and utilized in a decision-making process (e.g., a business decision). For example, the data in the core layer 24 may be relied upon by finance teams, marketing teams, sales teams, and the like. Thus, the system and method of the present disclosure may improve efficiency of data migration from a source 12 to a core layer 24. That is, the system and method of the present disclosure may improve the performance of a computer.

In some embodiments, the tables of the audit schema 20 include a job metadata table configured to hold job metadata information. The job metadata information may include source data information and target data information. An entry may be made by a stored procedure, in response to detecting that there is no existing entry for the job based on user inputs at the pipeline level. In some embodiments, the stored procedure is a combination of multiple SQL statements. The job metadata table may contain information about the source of the job. The job metadata table may include job identifiers, execution start and end times, status (success, failure, or in-progress), error messages, and/or performance metrics like processing duration and resource usage. By capturing this information, the job metadata table may provide insights into the operational aspects of the data pipeline, enabling monitoring, troubleshooting, optimization, and auditing of data processing activities. It may ensure transparency, aid in maintaining pipeline health, and support compliance by providing a comprehensive log of all job executions within the pipeline. TABLE 1, below, shows exemplary columns of the job metadata table along with their corresponding datatype and description. As the audit process runs, the job metadata table and/or other tables may be populated. Some jobs may run at various intervals (e.g., hourly, daily, weekly, monthly, etc.). Whenever a job runs, the audit process may run (e.g., as an automated process). The job metadata table may include any combination of columns enumerated in TABLE 1. In various embodiments, column(s) may be omitted and/or other suitable columns not listed in TABLE 1 may be added.

TABLE 1

| | Column Name | Datatype | Description |
|---|---|---|---|
| 1 | JOB_NAME | CHARACTER (255) | Job name representing the |
| | | | name of the job by developer's |
| | | | choice of name with no spaces |
| 2 | JOB_LAYER | CHARACTER (100) | Description of the job step/layer |
| 3 | SRC_SYSTEM | CHARACTER (100) | Source system name |
| 4 | SRC_DATABASENAME | CHARACTER (100) | Source database name |
| 5 | SRC_SCHEMANAME | CHARACTER(100) | Source schema name |
| 6 | SRC_TABLE_NAME | CHARACTER (100) | Source table name |
| 7 | SRC_USER | CHARACTER(100) | Source User name |
| 8 | SRC_COMPUTE | CHARACTER(100) | |
| 9 | TGT_SYSTEM | CHARACTER (100) | Target system name |
| 10 | TGT_DATABASENAME | CHARACTER (100) | Target database name |
| 11 | TGT_SCHEMANAME | CHARACTER (100) | Target Schema name |
| 12 | TGT_USER | CHARACTER (100) | Target table name |
| 13 | TGT_COMPUTE | CHARACTER (100) | |
| 14 | TGT_TABLE_NAME | CHARACTER (100) | Target table name |
| 15 | TGT_TABLE_TYPE | CHARACTER (100) | Target table type |
| 16 | PIPELINE_FRAMEWORK | CHARACTER(50) | Framework that loads the |
| | | | record |
| 17 | USE_CDC | BOOLEAN | Flag that indicates whether |
| | | | incremental loads are being |
| | | | done using CDC |

In some embodiments, the tables of the audit schema 20 include a CDC dates table. The CDC dates table may store date ranges for active jobs. The dates may be used to determine whether there has been change in the data. The CDC dates table may be based on custom logic, e.g., using incremental numbers. The CDC dates table may be used to store the CDC date range for active jobs or displayed for the most recent job run. Every job may require an entry in the CDC dates table. In some embodiments, only one entry per job is permitted; once the job is present in this table only updates are made to the existing entry. A new entry may be made by a stored procedure in response to detecting that there is no existing entry for the job (e.g., based on the user inputs at the pipeline level). In response to detecting that there is an existing entry and the previous job run does not indicate a state of failure, the CDC dates table may be backed up to a CDC dates history (“CDC_DATES_HIST”) table and a last extract status (e.g., “LastExtractStatus”) may be set to ‘C’. In response to there being an existing entry and the previous job run indicating the job failed (e.g., “status< >C”), then a new CDC window may be created. The CDC dates table may track dates and times when data changes occur in the source tables. This table may include fields such as the date and time of the change, the type of operation (insert, update, delete), and/or the source table and affected rows' identifiers. By maintaining a record of these timestamps, the CDC dates table may enable the pipeline to efficiently identify and process only the data that has changed since the last update, facilitating incremental data loading and synchronization. This approach may minimize the processing overhead, reduce latency, and ensure that the data pipeline remains efficient and up-to-date with the latest changes in the source data. The CDC dates table may include any combination of columns enumerated in TABLE 2. In various embodiments, column(s) may be omitted and/or other suitable columns not listed in TABLE 2 may be added.

TABLE 2

| | Column Name | Data Type | Description |
|---|---|---|---|
| 1 | JOB_NAME | CHARACTER (255) | Job name |
| | | | representing the |
| | | | name of the job by |
| | | | developer choice |
| | | | with no spaces |
| 2 | TABLENAME | CHARACTER(100) | Target table name |
| 3 | CDC_COLUMN_EXPRESSION | CHARACTER (100) | The source column |
| | | | in which the |
| | | | incremental change |
| | | | data is captured |
| 4 | EXTRACTSTARTDTTM | TIMESTAMP | Start date with |
| | | | timestamp |
| 5 | EXTRACTSTARTDTTMFORMAT | CHARACTER (255) | Start date with |
| | | | timestamp format |
| 6 | EXTRACTENDDTTM | TIMESTAMP | End date with |
| | | | timestamp |
| 7 | EXTRACTENDDTTMFORMAT | CHARACTER (255) | End date with |
| | | | timestamp format |
| 8 | LASTEXTRACTSTATUS | CHARACTER (1) | Status of the last |
| | | | extraction of CDC |
| | | | range |
| 9 | SOURCE_TIMEZONE | CHARACTER (100) | Timezone ID of the |
| | | | source (PST \| EST\| |
| | | | CST \| GMT) |
| 10 | ROLLING_WINDOW_OFFSET | NUMERIC | Offset value to be |
| | | | considered when |
| | | | computing |
| | | | timestamp range |
| 11 | OVERRIDEEXTRACTSTARTDTTM | DATETIMEOFFSET (6) | Static date time to |
| | | | override computed |
| | | | start dttm |
| 12 | OVERRIDEEXTRACTENDDTTM | DATETIMEOFFSET (6) | Static date time to |
| | | | override computed |
| | | | end dttm |
| 13 | OVERRIDEEXPIRATIONDTTM | DATETIMEOFFSET (6) | Timestamp until |
| | | | which above static |
| | | | start and end dates |
| | | | used for |
| 14 | NUMBERRANGEON | CHARACTER (1) | Flag Y or N to select |
| | | | numeric CDC range |
| 15 | EXTRACTSTARTRANGE | NUMERIC | Numeric range start |
| | | | value |
| 16 | EXTRACTENDRANGE | NUMERIC | Numeric range end |
| | | | value |
| 17 | STARTSQLON | CHARACTER (1) | Flag Y or N to start |
| | | | using below |
| | | | StartSQL logic |
| 18 | STARTSQL | CHARACTER (10000) | Custom select |
| | | | statement to |
| | | | calculate your |
| | | | custom start date or |
| | | | number range. |
| | | | Common SQL for |
| | | | both formats |
| 19 | ENDSQLON | CHARACTER (1) | Flag Y or N to start |
| | | | using below |
| | | | EndSQL logic |
| 20 | ENDSQL | CHARACTER (10000) | Custom select |
| | | | statement to |
| | | | calculate your |
| | | | custom end date or |
| | | | number range. |
| | | | Common SQL for |
| | | | both formats |
| 21 | PROCESS_ID | NUMERIC | Job execution ID to |
| | | | uniquely identify the |
| | | | run |
| | | | (Framework ID |
| | | | appended to |
| | | | numeric timestamp) |
| 22 | UPDATEDBY | CHARACTER (255) | User NTID or |
| | | | Service account that |
| | | | last updated the |
| | | | record |
| 23 | UPDATEDTTM | TIMESTAMP | Timestamp at which |
| | | | the record was last |
| | | | updated |

The tables of the audit schema 20 may include a CDC history table storing backed up CDC entries of runs of a previous job. The CDC history table may track and store changes made to the data in the source tables. This table may record every insert, update, and delete operation, including metadata such as timestamps, operation types, and/or user information, thus enabling the pipeline to efficiently capture incremental changes rather than processing entire datasets. By maintaining a detailed log of these changes, the CDC history table may facilitate real-time data synchronization, auditing, historical analysis, and ensure data integrity and compliance within the pipeline. This may allow for efficient data processing, reduce latency, and support analytics and reporting capabilities. The CDC history table may include any combination of columns enumerated in TABLE 3. In various embodiments, column(s) may be omitted and/or other suitable columns not listed in TABLE 3 may be added.

TABLE 3

| | Column Name | Data Type | Description |
|---|---|---|---|
| 1 | JOB_NAME | CHARACTER (255) | Job name |
| | | | representing for |
| | | | name of the job by |
| | | | developer choice |
| | | | name with no spaces |
| | | | (unique required |
| | | | field) |
| 2 | TABLENAME | CHARACTER (100) | Target table name |
| 3 | CDC_COLUMN_EXPRESSION | CHARACTER (100) | The source column |
| | | | using which the |
| | | | incremental change |
| | | | data is captured |
| 4 | EXTRACTSTARTDTTM | TIMESTAMP | Start date with |
| | | | timestamp |
| 5 | EXTRACTSTARTDTTMFORMAT | CHARACTER (255) | Start date with |
| | | | timestamp format |
| 6 | EXTRACTENDDTTM | TIMESTAMP | End date with |
| | | | timestamp |
| 7 | EXTRACTENDDTTMFORMAT | CHARACTER (255) | End date with |
| | | | timestamp format |
| 8 | LASTEXTRACTSTATUS | CHARACTER (1) | Status of the last |
| | | | extraction of CDC |
| | | | range |
| 9 | SOURCE_TIMEZONE | CHARACTER (100) | Timezone ID of the |
| | | | source (PST \| EST\| |
| | | | CST \| GMT) |
| 10 | ROLLING_WINDOW_OFFSET | NUMERIC | Offset value to be |
| | | | considered when |
| | | | computing timestamp |
| | | | range |
| 11 | OVERRIDEEXTRACTSTARTDTTM | DATETIMEOFFSET | Static date time to |
| | | (6) | override computed |
| | | | start dttm |
| 12 | OVERRIDEEXTRACTENDDTTM | DATETIMEOFFSET | Static date time to |
| | | (6) | override computed |
| | | | end dttm |
| 13 | OVERRIDEEXPIRATIONDTTM | DATETIMEOFFSET | Timestamp until |
| | | (6) | which above static |
| | | | start and end dates |
| | | | used for |
| 14 | NUMBERRANGEON | CHARACTER (1) | Flag Y or N to select |
| | | | numeric CDC range |
| 15 | EXTRACTSTARTRANGE | NUMERIC | Numeric range start |
| | | | value |
| 16 | EXTRACTENDRANGE | NUMERIC | Numeric range end |
| | | | value |
| 17 | STARTSQLON | CHARACTER (1) | Flag Y or N to start |
| | | | using below StartSQL |
| | | | logic |
| 18 | STARTSQL | CHARACTER | Custom select |
| | | (10000) | statement to |
| | | | calculate your custom |
| | | | start date or number |
| | | | range. Common SQL |
| | | | for both formats |
| 19 | ENDSQLON | CHARACTER (1) | Flag Y or N to start |
| | | | using below EndSQL |
| | | | logic |
| 20 | ENDSQL | CHARACTER | Custom select |
| | | (10000) | statement to |
| | | | calculate your custom |
| | | | end date or number |
| | | | range. Common SQL |
| | | | for both formats |
| 21 | PROCESS_ID | NUMERIC | Job execution ID to |
| | | | uniquely identify the |
| | | | run |
| | | | (Framework ID |
| | | | appended to numeric |
| | | | timestamp) |
| 22 | UPDATEDBY | CHARACTER (255) | User NTID or Service |
| | | | account that last |
| | | | updated the record |
| 23 | UPDATEDTTM | TIMESTAMP | Timestamp at which |
| | | | the record was last |
| | | | updated |

The tables of the audit schema 20 may include a job execution log table holding execution log information at a job name and a step layer for each process. The job execution log table may include start and end timestamps, row counts, and/or fields such as read, exported, inserted, updated, deleted, duplicate and/or errors. The job execution log table may be updated by a stored procedure (e.g., “usp_log_exec_stats”). The job execution log table may capture detailed logs of each pipeline job's execution. This table may contain fields such as job identifiers, start and end times, execution status (success, failure, or in-progress), error messages, and/or performance metrics like processing duration and resource consumption. By logging this information, the job execution log table may provide a comprehensive audit trail, facilitating monitoring, troubleshooting, and performance tuning of the data pipeline. It may enable data engineers to track the health and efficiency of the pipeline, quickly identify and resolve issues, and ensure the reliable and consistent execution of data processing tasks. The job execution log table may include any combination of columns enumerated in TABLE 4. In various embodiments, column(s) may be omitted and/or other suitable columns not listed in TABLE 4 may be added.

TABLE 4

| | Column Name | Data Type | Description |
|---|---|---|---|
| 1 | JOB_NAME | CHARACTER | Job name representing for name of the job |
| | | (255) | by developer choice name with no spaces |
| 2 | STEP_DESC | CHARACTER | Description of the step at which the logging |
| | | (100) | is being done |
| 3 | STEP_ORDER | NUMERIC | Step order |
| 4 | PROCESS_ID | NUMERIC | Job execution ID to uniquely identify the run |
| | | | (Framework ID appended to numeric |
| | | | timestamp) |
| 5 | STATUS | CHARACTER | Status of the job either A(Active), |
| | | (1) | C(Completed) or F(Failed) |
| 6 | RUNUSER | CHARACTER | User NTID or Service account that |
| | | (255) | executed the job |
| 7 | READ_ROWS | NUMERIC | Number of rows read |
| 8 | EXPORTED_ROWS | NUMERIC | Number of rows exported |
| 9 | INSERTED_ROWS | NUMERIC | Number of rows inserted |
| 10 | UPDATED_ROWS | NUMERIC | Number of rows updated |
| 11 | DUPLICATE_ROWS | NUMERIC | Number of duplicate rows identified |
| 12 | DELETED_ROWS | NUMERIC | Number of deleted rows |
| 13 | ERRORED_ROWS | NUMERIC | Number of rows errored out |
| 14 | STARTDTTM | TIMESTAMP | Start timestamp of execution |
| 15 | ENDDTTM | TIMESTAMP | End timestamp of execution |
| 16 | PIPELINE_RUN_ID | CHARACTER | Pipeline Run ID to uniquely identify the job's |
| | | (50) | run (in ADF) |
| 17 | ERROR_MSG | CHARACTER | Error M |
| 18 | UPDATEDBY | CHARACTER | User NTID or Service account that last |
| | | (255) | updated the record |
| 19 | UPDATEDTTM | TIMESTAMP | Timestamp at which the record was last |
| | | | updated |

The tables of the audit schema 20 may include a job status table holding status information of a most recent/current active job run. This information may be updated by the stored procedures (e.g., “udp_start_dataflow_job” and “usp_end_dataflow_job” at the start and end of the job execution, respectively). The job status table may include information such as what job ran, the status of the job, and when the job ran. The job status table may record the current status of each job within the pipeline. This job status table may include job identifiers, job names, execution start and end times, current status (e.g., pending, running, completed, failed), and/or relevant metadata like error codes or messages. By maintaining real-time status information, the job status table may enable effective monitoring and management of pipeline operations, allowing data engineers to quickly identify and address issues, optimize job scheduling, and ensure the smooth and efficient execution of data processing workflows. It may serve as a reference point for tracking the progress and health of pipeline jobs. The job status table may include any combination of columns enumerated in TABLE 5. In various embodiments, column(s) may be omitted and/or other suitable columns not listed in TABLE 5 may be added.

TABLE 5

| | Column Name | Data Type | Description |
|---|---|---|---|
| 1 | JOB_NAME | CHARACTER | Job name representing for name of the |
| | | (255) | job by developer choice name with no |
| | | | spaces (required field, PK) |
| 2 | JOB_LAYER | CHARACTER | |
| | | (100) | |
| 3 | PROCESS_ID | NUMERIC | Job execution ID to uniquely identify the |
| | | | job |
| 4 | STATUS | CHARACTER | Status of the job either A(Active), |
| | | (1) | C(Completed) or F(Failed) |
| 5 | LASTCHECKPOINT | CHARACTER | Timestamp of last successful run of the |
| | | (255) | job |
| 6 | RECOVERYMODE | NUMERIC | Denotes if the job was recovered |
| 7 | FORCERESTART | NUMERIC | Denotes if a job was a forcefully |
| | | | restarted |
| 8 | RUNUSER | CHARACTER | Job execution user |
| | | (255) | |
| 9 | STARTDTTM | TIMESTAMP | Timestamp of the job start time |
| 10 | ENDDTTM | TIMESTAMP | Timestamp of the job end time |
| 11 | UPDATEDBY | CHARACTER | User NTID or Service account that last |
| | | (255) | updated the record |
| 12 | UPDATEDTTM | TIMESTAMP | Timestamp at which the record was last |
| | | | updated |

The tables of the audit schema 20 may include an audit balance table for computing an audit check between source and target counts. The audit balance table may be updated by a stored procedure (e.g., “usp_audit_balance”). The audit balance table may ensure data integrity and accuracy by comparing and validating data between different stages of the pipeline. The table may include fields such as record counts, sums, or checksums of key data attributes before and after processing, timestamps, and/or identifiers for the data batches or jobs. By storing these audit metrics, the audit balance table may allow data engineers to verify that the data transformations and movements have been executed correctly, detect discrepancies or data loss, and maintain a reliable and transparent record of data processing activities. It may help uphold data quality and compliance by providing a systematic way to balance and reconcile data throughout the pipeline. The audit balance table may include any combination of columns enumerated in TABLE 6. In various embodiments, column(s) may be omitted and/or other suitable columns not listed in TABLE 6 may be added.

TABLE 6

| | Column Name | Data Type | Description |
|---|---|---|---|
| 1 | JOB_NAME | CHARACTER | Job name representing for |
| | | (255) | name of the job by developer |
| | | | choice name with no spaces |
| 2 | STEP_DESC | CHARACTER | Description of the step at |
| | | (100) | which the logging is being |
| | | | done |
| 3 | STEP_ORDER | NUMERIC | Step order |
| 4 | PROCESS_ID | NUMERIC | Job execution ID to uniquely |
| | | | identify the run (Framework |
| | | | ID appended to numeric |
| | | | timestamp) |
| 5 | SOURCE_COUNT | NUMERIC | Count of records imported |
| | | | from the source |
| 6 | TARGET_COUNT | NUMERIC | Count of records exported to |
| | | | the target |
| 7 | TARGET_ERR_COUNT | NUMERIC | Count of records errored out |
| | | | from the target |
| 8 | AUDIT_DIFF | NUMERIC | Difference between source |
| | | | and target counts |
| 9 | ALLOWED_THRESHOLD_CNT | NUMERIC | Threshold of records allowed |
| | | | in target |
| 10 | ALLOWED_THRESHOLD_PRONT | DECIMAL | Threshold % of source |
| | | | records allowed in target - set |
| | | | by the user |
| 11 | STATUS | CHARACTER | Status of Audit check |
| | | (255) | (PASS/FAIL) |
| 12 | TGT_TABLE_NAME | CHARACTER | Name of the target table |
| | | (100) | |
| 13 | AUDIT_DTTM | TIMESTAMP | Timestamp at which the audit |
| | | | check was done |
| 14 | UPDATEDBY | CHARACTER | User NTID or Service account |
| | | (255) | that last updated the record |
| 15 | UPDATEDTTM | TIMESTAMP | Timestamp at which the |
| | | | record was last updated |

The tables of the audit schema 20 may include a flat file control table for controlling injection and storing metadata of flat files. The flat files may be text-based files that store data in a plain, unstructured format (e.g., with one record per line). In some embodiments, the flat file control table tracks what was processed, when, and by what job. A determination about the file source can be made based on the flat file control table. The flat file control table may be used to manage and track the processing of flat files that are ingested into the pipeline. This table may include fields such as file names, file paths, ingestion timestamps, file sizes, processing statuses (e.g., pending, processing, completed, failed), and/or any error messages encountered during processing. By maintaining this information, the flat file control table may allow data engineers to monitor the ingestion and processing of flat files, ensure that all files are accounted for, detect and resolve issues promptly, and maintain an organized and efficient workflow. It may serve as a central point of reference for the status and history of flat file operations within the data pipeline. The flat file control table may include any combination of columns enumerated in TABLE 7. In various embodiments, column(s) may be omitted and/or other suitable columns not listed in TABLE 7 may be added.

TABLE 7

| | Column Name | Data Type | Description |
|---|---|---|---|
| 1 | JOB_NAME | CHARACTER | Job name representing for name of |
| | | (255) | the job by developer choice name |
| | | | with no spaces |
| 2 | STEP_DESC | CHARACTER | Description of the step at which the |
| | | (100) | logging is being done |
| 3 | STEP_ORDER | NUMERIC | Step order |
| 4 | FILENAME | CHARACTER | Name of the file ingested |
| | | (255) | |
| 5 | FILESIZE | CHARACTER | Size of the file ingested |
| | | (255) | |
| 6 | FILECOUNT | CHARACTER | Number of files ingested |
| | | (255) | |
| 7 | FILE_RECEIVEDPATH | CHARACTER | File landing/input path |
| | | (8000) | |
| 8 | FILE_RECEIVEDDTTM | TIMESTAMP | Timestamp at which file is received |
| 9 | FILE_ERRORMSG | CHARACTER | Logs error message when parsing |
| | | (8000) | file |
| 10 | TGT_TABLE_NAME | CHARACTER | Name of the target table |
| | | (100) | |
| 11 | STATUS | CHARACTER | Status of Audit check (PASS/FAIL) |
| | | (255) | |
| 12 | PROCESS_ID | NUMERIC | Framework ID appended to numeric |
| | | | timestamp |
| 13 | UPDATEDBY | CHARACTER | User NTID or Service account that |
| | | (255) | last updated the record |
| 14 | UPDATEDTTM | TIMESTAMP | Timestamp at which the record was |
| | | | last updated |

The tables of the audit schema 20 may include a job error record table holding error information. The fields of job name and process ID may be used to identify the source of the error. These fields may be populated as the job is run. The job error record table may capture and store detailed information about errors and exceptions that occur during the execution of pipeline jobs. This table may include fields such as job identifiers, timestamps of when the error occurred, error codes, error messages, the stage or component of the pipeline where the error was encountered, and/or any relevant data that caused the error. By maintaining a comprehensive log of errors, the job error record table may enable data engineers to monitor, diagnose, and troubleshoot issues effectively, ensuring the reliability and robustness of the data pipeline. It may help data engineers identify recurring problems, understand failure patterns, and implement corrective actions to improve the overall performance and stability of the pipeline. The job error record table may include any combination of columns enumerated in TABLE 8. In various embodiments, column(s) may be omitted and/or other suitable columns not listed in TABLE 8 may be added.

TABLE 8

| | Column Name | Data Type | Description |
|---|---|---|---|
| 1 | JOB_NAME | CHARACTER (255) | Job name representing |
| | | | for name of the job by |
| | | | developer choice name |
| | | | with no spaces |
| 2 | PROCESS_ID | NUMERIC | Framework ID |
| | | | appended to numeric |
| | | | timestamp |
| 3 | JOB_LAYER | VARCHAR(100) | Description of the step |
| | | | at which the logging is |
| | | | being done |
| 3 | RECORD_SOURCE_TYPE_DESC | VARCHAR(50) | Record Source Type |
| | | | Desc |
| 4 | KEY_COLUMNS_LIST | VARCHAR(5000) | Key columns list |
| 5 | ALL_COLUMNS_LIST | VARCHAR(10000) | All Columns List |
| 6 | ERROR_DESC | VARCHAR(1000) | Error Description |
| 7 | ERROR_RECORD_CONTENT | VARCHAR(10000) | Error record content |
| 8 | ERROR_DTTM | TIMESTAMP_NTZ(9) | Error Timestamp |

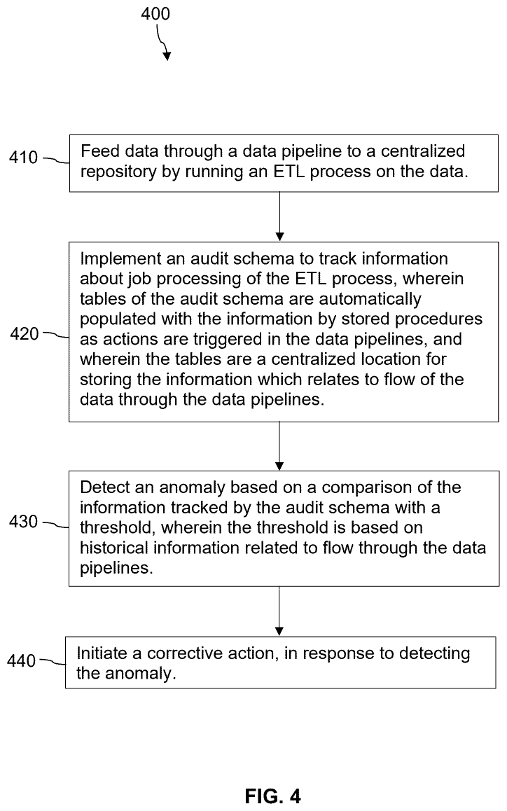

Referring to FIG. 4, a method 400 of detecting an anomaly in data may include the step 410 of feeding data through a data pipeline to a centralized repository by running an ETL process on the data; the step 420 of implementing an audit schema to track information about job processing of the ETL process, wherein tables of the audit schema are automatically populated with the information by stored procedures as actions are triggered in the data pipelines, and wherein the tables are a centralized location for storing the information which relates to flow of the data through the data pipelines; the step 430 of detecting an anomaly based on a comparison of the information tracked by the audit schema with a threshold, wherein the threshold is based on historical information related to flow through the data pipelines; and the step 440 of initiating a corrective action, in response to detecting the anomaly. The anomaly may be something wrong or apparently wrong with the data transfer. For example, the anomaly may be an error or may be based on error. For example, there may be an explicit indication that an error has occurred. In some embodiments, the anomalies may be based on crossing count. For example, the anomaly may be an indication that significantly less records have been received than is expected or that have been received in similar circumstances. For example, the anomaly may be that only ten records have been received in a month while in the previous five months a thousand records were received. In some embodiments, the anomaly is based on audit balance. For example, a mismatch between a number of populated records and a number of read records may be an anomaly. An alert may be triggered in response to detecting the anomaly. The alert may be a message to an IT professional to investigate and/or correct the potential issue.

The tables may include a job metadata table, a CDC table, a job execution log table, a job status table, an audit balance table, a flat file control table, and/or a job error record table. The job metadata table may hold job metadata information and may include source data information and target data information. The CDC dates table may store date ranges for active jobs. The CDC history table may store backed up CDC entries of runs of a previous job. The job execution log table may hold execution log information of a job name and a step layer for each process. The job status table may hold status information of a most recent active job run. The audit balance table may be for computing an audit check between source and target counts. The flat file control table may be for controlling injection and storing metadata of flat files. The job error record table may hold error information.

The system and method of the present disclosure may have the advantage of reducing overhead by using tables according to the audit schema which are centralized, uniform, and able to accommodate a variety of different ETL processes (file, database, real time, API, etc.). By automatically populating tables of an audit schema as actions are triggered in the data pipeline, the need to create an error table and a CDC table for every data file is eliminated.

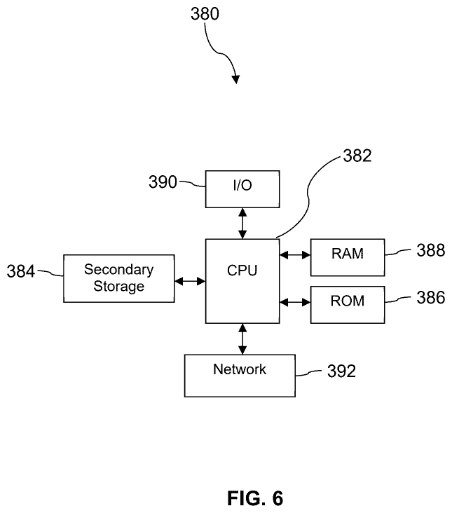

FIG. 6 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC) and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A method of detecting an anomaly in data, comprising:
feeding, by one or more processors, data through data pipelines to a centralized repository by running an Extract, Transform, Load (ETL) process on the data;
implementing, by the one or more processors, an audit schema having tables to track information about job processing of the ETL process, wherein the tables are a centralized location for storing the information which relates to flow of the data consolidated from multiple data sources through the data pipelines, and wherein the tables include a job error record table that associates information about errors in the tracked information and respective sources of the errors in a single centralized table;
automatically populating the tables of the audit schema from the data pipelines through the ETL process with the information consolidated from the multiple data sources in the tables by stored procedures as actions are triggered in the data pipelines;
comparing information automatically populated to one of the tables with a threshold, wherein the threshold is based on historical information related to flow through the data pipelines;
detecting an anomaly based on the comparison;
initiating a corrective action in response to detecting the anomaly, including at least outputting an alert to a graphical user interface in response to detecting the anomaly; and
capturing the anomaly to the job error record table with an association to its error source.

2. The method of claim 1, wherein the tables further comprise a job metadata table, a change data capture (CDC) table, a job execution log table, a job status table, an audit balance table, and a flat file control table.

3. The method of claim 1, wherein the tables further comprise a job metadata table holding job metadata information, which comprises source data information and target data information.

4. The method of claim 1, wherein the tables further comprise a change data capture (CDC) dates table storing date ranges for active jobs, and a change data capture (CDC) history table storing backed up CDC entries of runs of a previous job.

5. (canceled)

6. The method of claim 1, wherein the tables further comprise a job execution log table holding a job name and a step layer for each process, and a job status table holding status information of a most recent active job run.

7. (canceled)

8. The method of claim 1, wherein the tables further comprise:
an audit balance table, wherein the audit balance table is used for computing an audit check between source and target counts; and
a flat file control table, wherein the flat file control table is used for controlling injection and storing metadata of flat files.

9. (canceled)

10. A non-transitory computer-readable medium storing instructions that, when executed by a processor, cause the processor to execute the method of claim 1.

11. A system for detecting an anomaly in data, comprising:
data pipelines configured to feed data to a centralized repository by running an Extract, Transform, Load (ETL) process on the data;
an audit schema configured to track information about job processing of the ETL process; and
stored procedures comprising instructions executable by a processor to automatically populate tables of the audit schema from the data pipelines through the ETL process with the information consolidated from multiple data sources by stored procedures as actions are triggered in the data pipelines, wherein the tables are a centralized location for storing the information which relates to flow of the data consolidated from the multiple data sources through the data pipelines, and wherein the tables comprise a job metadata table, a change data capture (CDC) table, a job execution log table, a job status table, an audit balance table, a flat file control table, and a job error record table, each table being a single centralized table for the information received from the multiple data sources;
an anomaly detector configured to:
compare at least a portion of the information automatically populated to one of the tables with a threshold, wherein the threshold is based on historical information related to flow through the data pipelines; and
detect an anomaly based on the comparison; and
one or more processors to initiate a corrective action in response to detecting the anomaly, including at least outputting an alert to a graphical user interface in response to detecting the anomaly.

12. The system of claim 11, wherein the job metadata table holds job metadata information, which comprises source data information and target data information.

13. The system of claim 11, wherein the CDC dates table stores date ranges for active jobs.

14. The system of claim 11, wherein the CDC history table stores backed up CDC entries of runs of a previous job.

15. The system of claim 11, wherein the job execution log table holds a job name and a step layer for each process.

16. A system for detecting an anomaly in data, comprising:
data pipelines configured to feed data to a centralized repository by running an Extract, Transform, Load (ETL) process on the data;
an audit schema configured to track information about job processing of the ETL process;
stored procedures comprising instructions executable by a processor to automatically populate tables of the audit schema from the data pipelines through the ETL process with the information consolidated from multiple data sources by stored procedures as actions are triggered in the data pipelines;
an anomaly detector configured to:
compare at least a portion of the information automatically populated to one of the tables with a threshold, wherein the threshold is based on historical information related to flow through the data pipelines; and
detect an anomaly based on the comparison; and
one or more processors to initiate a corrective action in response to detecting the anomaly, including at least outputting an alert to a graphical user interface in response to the at least a portion of the information falling below the threshold.

17. The system of claim 16, wherein the tables comprise a job status table holding status information of a most recent active job run.

18. The system of claim 16, wherein the tables comprise an audit balance table, wherein the audit balance table is used for computing an audit check between source and target counts.

19. The system of claim 16, wherein the tables comprise a flat file control table, wherein the flat file control table is used for controlling injection and storing metadata of flat files.

20. The system of claim 16, wherein the tables comprise a job error record table holding error information.

21. The method of claim 1, wherein the anomaly is a volume of the files passing through one of the data pipelines falling below the threshold.

22. The system of claim 11, wherein the anomaly is a volume of the files passing through one of the data pipelines falling below the threshold.

23. The system of claim 16, wherein the anomaly is a volume of the files passing through one of the data pipelines falling below the threshold.
